(19) United States
(12) Patent Application Publication
(10) Pub. No.: US 2009/0088105 A1
(43) Pub. Date: Apr. 2, 2009

(54) METHOD AND SYSTEM FOR UTILIZING A PROGRAMMABLE COPLANAR WAVEGUIDE OR MICROSTRIP BANDPASS FILTER FOR UNDERSAMPLING IN A RECEIVER

(76) Inventor: Ahmadreza Rofougaran, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 11/864,421

(22) Filed: Sep. 28, 2007

(51) Int. Cl. G06F 3/033

(52) U.S. Cl. 455/130

(57) ABSTRACT

Methods and systems for a programmable coplanar or microstrip bandpass filter for undersampling in a receiver are disclosed and may include band-limiting a received wireless signal utilizing one or both of a programmable microstrip bandpass filter and a coplanar waveguide bandpass filter and undersampling the band-limited received wireless signal. A center frequency of the programmable microstrip bandpass filter may be tuned by adjusting a capacitance or an inductance of the programmable microstrip bandpass filter. The bandwidth of the programmable microstrip bandpass filter may be also be adjusted. A center frequency of the programmable coplanar waveguide bandpass filter may be tuned by adjusting a capacitance or an inductance of the programmable coplanar waveguide bandpass filter. The bandwidth of the programmable coplanar waveguide bandpass filter may also be adjusted. The band-limited, received wireless signal may be undersampled utilizing a sample and hold circuit.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to wireless communication. More specifically, certain embodiments of the invention relate to a method and system for a programmable coplanar or microstrip bandpass filter for undersampling in a receiver.

### BACKGROUND OF THE INVENTION

In 2001, the Federal Communications Commission (FCC) designated a large contiguous block of 7 GHz bandwidth for communications in the 57 GHz to 64 GHz spectrum. This frequency band may be used by the spectrum users on an unlicensed basis, that is, the spectrum is accessible to anyone, subject to certain basic, technical restrictions such as maximum transmission power and certain coexistence mechanisms. The communications taking place in this band are often referred to as ‘60 GHz communications’. With respect to the accessibility of this part of the spectrum, 60 GHz communications is similar to other forms of unlicensed spectrum use, for example Wireless LANs or Bluetooth in the 2.4 GHz ISM bands. However, communications at 60 Hz may be significantly different in aspects other than accessibility. For example, 60 GHz signals may provide markedly different communications channel and propagation characteristics, not least due to the fact that 60 GHz radiation is partly absorbed by oxygen in the air, leading to higher attenuation with distance. On the other hand, since a very large bandwidth of 7 GHz is available, very high data rates may be achieved. Among the applications for 60 GHz communications are wireless personal area networks, wireless high-definition television signal, for example from a set top box to a display, or Point-to-Point links.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for wireless communication, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary wireless communication system, in connection with an embodiment of the invention.

FIG. 2 is a block diagram illustrating an undersampling circuit utilizing a programmable bandpass filter, in accordance with an embodiment of the invention.

FIG. 3A is a block diagram illustrating a cross sectional view of a microstrip bandpass filter, in accordance with an embodiment of the invention.

FIG. 3B is a block diagram of an exemplary microstrip bandpass filter, in accordance with an embodiment of the invention.

FIG. 3C is a block diagram illustrating a cross sectional view of a coplanar waveguide bandpass filter, in accordance with an embodiment of the invention.

FIG. 3D is a block diagram of an exemplary coplanar waveguide bandpass filter, in accordance with an embodiment of the invention.

FIG. 4 is a block diagram illustrating exemplary received RF, bandpass filtered, and undersampled signals, in accordance with an embodiment of the invention.

FIG. 5 is a flow diagram illustrating an exemplary programmable bandpass filter and undersampling process, in accordance with an embodiment of the invention.

### DETAILED DESCRIPTION OF THE INVENTION

Certain aspects of the invention may be found in a method and system for a programmable coplanar or microstrip bandpass filter for undersampling in a receiver. Exemplary aspects of the invention may comprise band-limiting a received wireless signal utilizing one or both of a programmable microstrip bandpass filter and a coplanar waveguide bandpass filter and undersampling the band-limited received wireless signal. A center frequency of the programmable microstrip bandpass filter may be tuned by adjusting a capacitance or an inductance of the programmable microstrip bandpass filter. The bandwidth of the programmable microstrip bandpass filter may also be adjusted. A center frequency of the programmable coplanar waveguide bandpass filter may be tuned by adjusting a capacitance or an inductance of the programmable coplanar waveguide bandpass filter. The bandwidth of the programmable coplanar waveguide bandpass filter may also be adjusted. The band-limited, received wireless signal may be undersampled utilizing a sample and hold circuit.

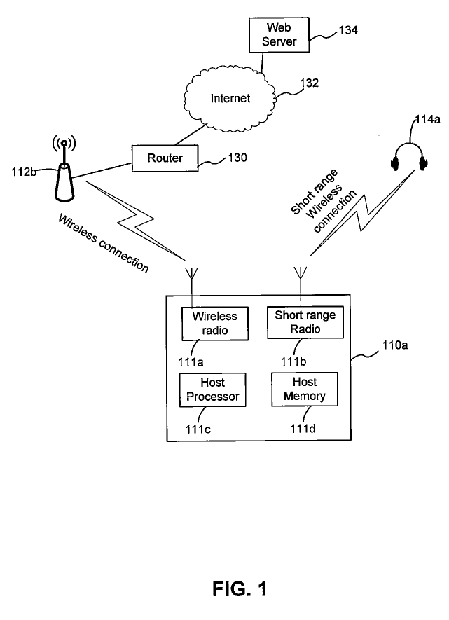

FIG. 1 is a diagram illustrating an exemplary wireless communication system, in connection with an embodiment of the invention. Referring to FIG. 1, there is shown an access point 112b, a computer 110a, a headset 114a, a router 130, the Internet 132 and a web server 134. The computer or host device 110a may comprise a wireless radio 111a, a short-range radio 111b, a host processor 111c, and a host memory 111d. There is also shown a wireless connection between the wireless radio 111a and the access point 112b, and a short-range wireless connection between the short-range radio 111b and the headset 114a.

Frequently, computing and communication devices may comprise hardware and software to communicate using multiple wireless communication standards. The wireless radio 111a may be compliant with a mobile communications standard, for example. There may be instances when the wireless radio 111a and the short-range radio 111b may be active concurrently. For example, it may be desirable for a user of the computer or host device 110a to access the Internet 132 in order to consume streaming content from the Web server 134. Accordingly, the user may establish a wireless connection between the computer 110a and the access point 112b. Once this connection is established, the streaming content from the Web server 134 may be received via the router 130, the access point 112b, and the wireless connection, and consumed by the computer or host device 110a.

It may be further desirable for the user of the computer 110a to listen to an audio portion of the streaming content on the headset 114a. Accordingly, the user of the computer 110a may establish a short-range wireless connection with the headset 114a. Once the short-range wireless connection is established, and with suitable configurations on the computer enabled, the audio portion of the streaming content may be consumed by the headset 114a. In instances where such advanced communication systems are integrated or located within the host device 110a, the radio frequency (RF) generation may support fast-switching to enable support of multiple communication standards and/or advanced wideband systems like, for example, Ultrawideband (UWB) radio. Other applications of short-range communications may be wireless High-Definition TV (W-HDTV), from a set top box to a video display, for example. W-HDTV may require high data rates that may be achieved with large bandwidth communication technologies, for example UWB and/or 60-GHz communications.

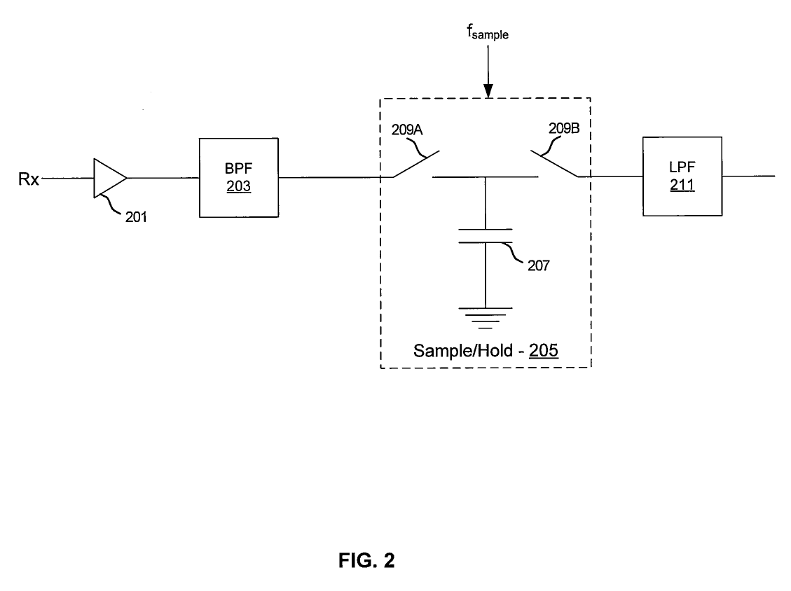

FIG. 2 is a block diagram illustrating an undersampling circuit utilizing a programmable bandpass filter, in accordance with an embodiment of the invention. Referring to FIG. 2, there is shown a low noise amplifier (LNA) 201a band pass filter (BPF) 203 a sample and hold (S/H) circuit 205 and a low pass filter (LPF) 211. The S/H circuit 205 may comprise a capacitor 207 and switches 209A and 209B.

The LNA 201 may comprise suitable circuitry, logic and/or code that may enable the amplification of a received signal. The gain level of the LNA 201 may be adjustable, depending on, for example, a magnitude of the received signal and the desired signal level at the output of the LNA 201. The input of the LNA 201 may be enabled to receive an RF signal at a frequency of f_{RF}. The output of the LNA 201 may be communicatively coupled to the BPF 203.

The BPF 203 may comprise suitable circuitry, logic and/or code that may enable band-limiting a received signal by only allowing a signal within a particular frequency band to pass. The BPF 203 may comprise a programmable microstrip (MS) or coplanar waveguide (CPW) filter, such that the allowed frequency band may be adjustable. The microstrip or coplanar waveguide filter may comprise conductive paths in a dielectric material to create a variable inductance and capacitance structure that may be utilized to create a bandpass filter. By changing the dimensions, spacing and/or arrangement of microstrip or coplanar waveguide sections within the bandpass filter, the center frequency and bandwidth may be adjusted.

The S/H CIRCUIT 205 may comprise suitable circuitry, logic and/or code that may enable sampling a received signal at a desired sampling frequency, as indicated by the input signal fₛₐₘₚₗₑ in FIG. 2. The switches 209A and 209B may open and close at the sampling frequency to couple the input signal received from the BPF 203. The capacitor 207 may enable storage of charge to hold the sampled voltage before communicating it to the LPF 211.

The LPF 211 may comprise suitable circuitry, logic and/or code that may enable receiving an input signal and passing only signals with a frequency below a desired cutoff frequency. The LPF 211 may comprise an RC circuit, or similar, with the cutoff frequency determined by the resistance and capacitance values.

In operation, an input RF signal may be communicated to the LNA 201, which may amplify the signal with a desired gain level. The amplified signal may then be communicatively coupled to the BFP 203. The BPF 203 may filter out signals at all frequencies except those within the desired frequency. The filtered signal may then be communicated to the S/H circuit 205 for sampling.

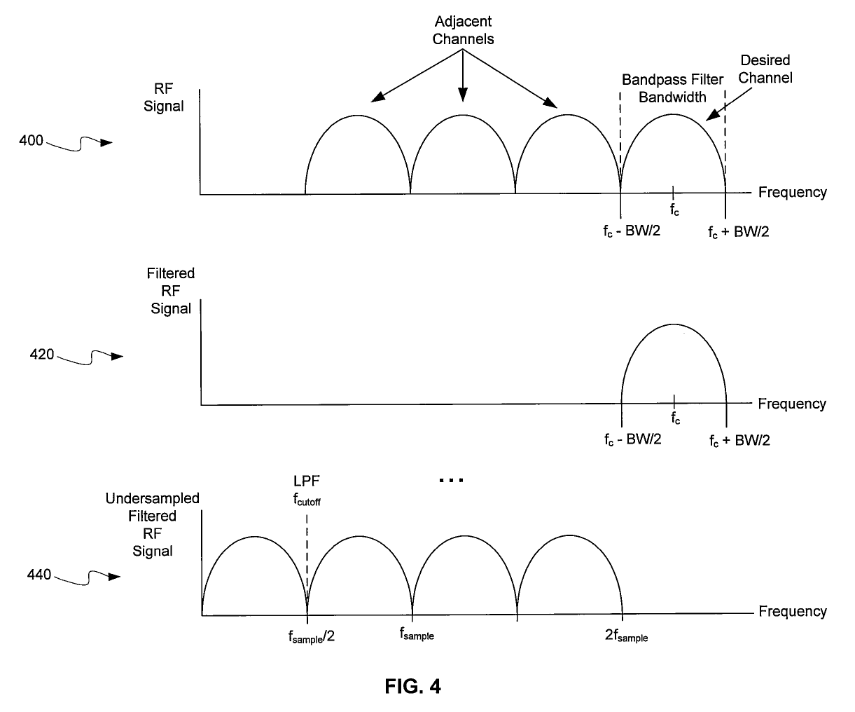

Sampling theory may require that to prevent aliasing, a signal may be sampled at twice the frequency of the signal. Accordingly, if a wideband signal may first be bandpass filtered to only the frequency range of interest, then a lower sampling frequency of greater than or equal to twice the bandpass filter bandwidth, may be utilized. In this regard, a microstrip or coplanar waveguide filter may enable receiving signals up to extremely high frequencies. Accordingly the programmable microstrip or coplanar waveguide filter may be centered around a desired RF frequency and the filtered signal may be sampled at a frequency greater than twice the bandwidth of the filter rather than greater than twice the frequency of the received RF signal. For example, a received signal may comprise a 60 GHz carrier modulated by a signal with baseband bandwidth of less than 5 GHz. In this manner, the microstrip filter may be controlled to be centered at 60 GHz with a bandwidth of 5 GHz and the resulting signal may be sampled at 10 GHz, rather than the 120 GHz sampling rate required by signal theory for the received RF signal without band-limiting. The resulting signal may then be low pass filtered by the LPF 211. The filtering and sampling process is described further with respect to FIG. 4.

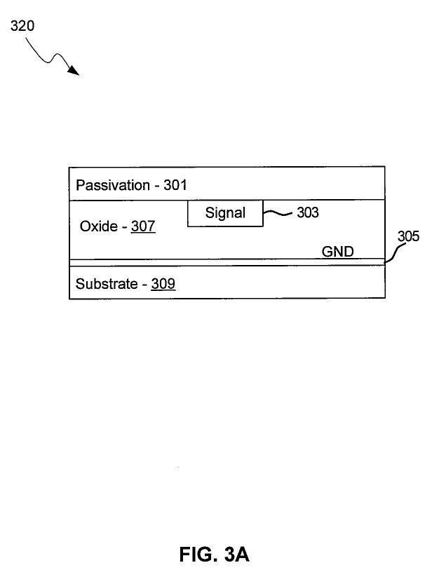

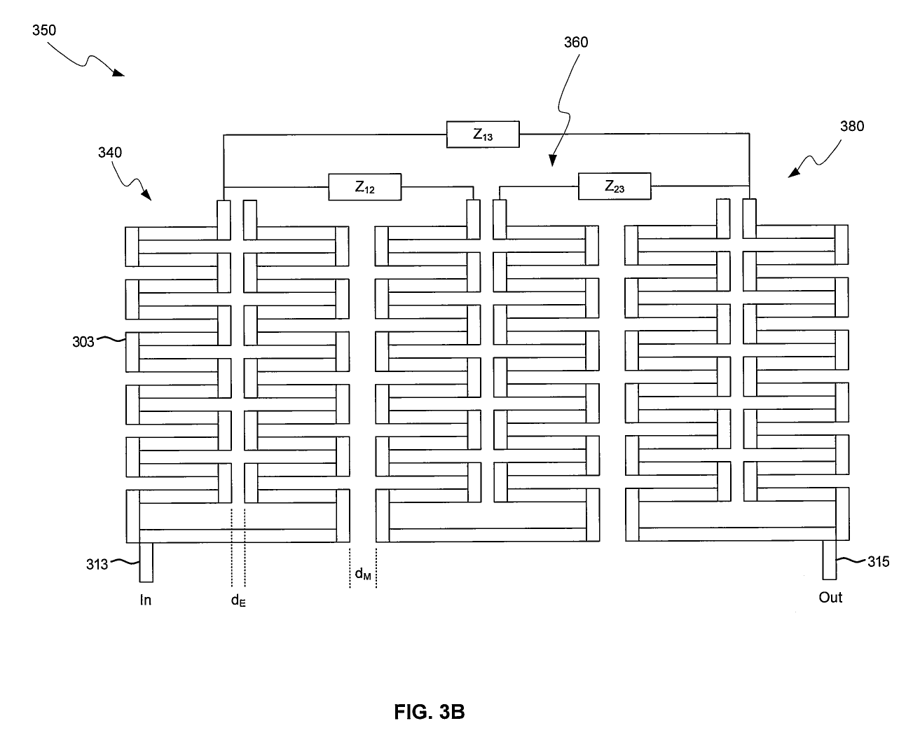

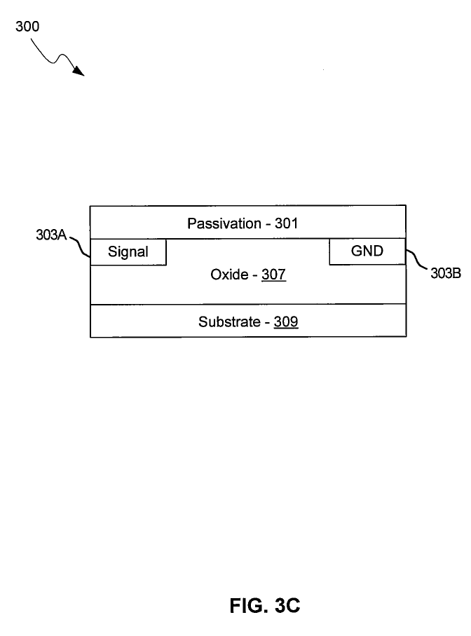

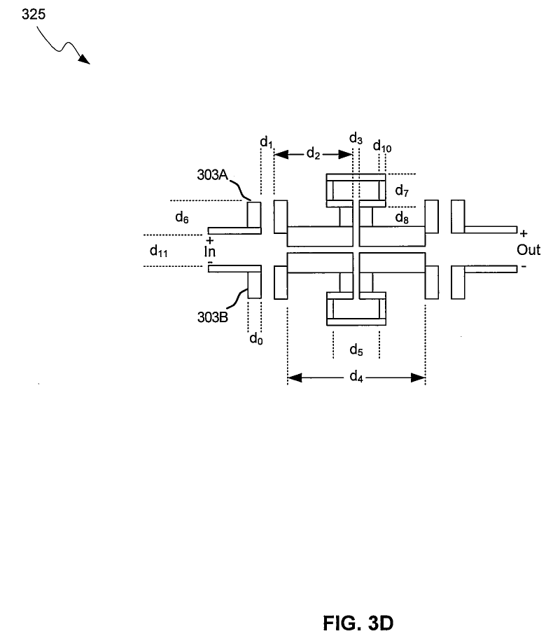

FIG. 3A is a block diagram illustrating a cross-sectional view of a microstrip bandpass filter, in accordance with an embodiment of the invention. Referring to FIG. 3A, there is shown a microstrip bandpass filter (MS-BPF) 320. The MS-BPF 320 may comprise a passivation layer 301, a signal conductive line 303, a ground plane 305, an oxide layer 307 and a substrate 309.

The passivation layer 301 may comprise an oxide, nitride or other insulating layer that may provide electrical isolation between the signal conductive line 303, the ground plane 305 and other circuitry on the substrate 309. The passivation layer 301 may provide protection from environmental factors for the underlying layers of the MS-BPF 320. In addition, the passivation layer 301 may be selected based on its dielectric constant and its effect on the electric field that may be present between conductive lines.

The signal conductive line 303 may comprise metal traces embedded in the oxide layer 307. In another embodiment of the invention, the signal conductive line 303 may comprise poly-silicon or other conductive material. The separation and the voltage potential between the signal conductive line 303 and the ground plane 305 may determine the electric field generated therein. In addition, the dielectric constant of the oxide 307 may also determine the electric field between the signal conductive line 303 and the ground plane 305.

The oxide layer 307 may comprise SiO₂ or other oxide material that may provide a high resistance insulating layer between the signal conductive line 303 and the ground plane 305. In addition, the oxide layer 307 may provide a means for configuring the electric field between the signal conductive line 303 and the ground plane 305 by the selection of an oxide material with an appropriate dielectric constant.

The substrate 309 may comprise a semiconductor or insulator material that may provide mechanical support for the MS-BPF 320 and other devices that may be integrated. The substrate 309 may comprise Si, GaAs, sapphire, InP, GaO, ZnO, CdTe, CdZnTe and/or Al₂O₃, for example, or any other substrate material that may be suitable for integrating microstrip structures.

In operation, an AC signal may be applied across the signal conductive line 303 and the ground plane 305. The spacing between the conductive line 303 and the ground plane 305, as well as the pattern of the conductive lines, may generate an inductance and a capacitance that may be utilized for filtering purposes, specifically bandpass filtering, in the present invention. In addition, programmable impedances may be coupled across the microstrip devices in the MS-BFP 320 to tune the center frequency and bandwidth and will be described further with respect to FIG. 3B.

FIG. 3B is a block diagram of an exemplary microstrip bandpass filter, in accordance with an embodiment of the invention. Referring to FIG. 3C, there is shown a microstrip bandpass filter 350 comprising three resonator sections 340, 360 and 380, an input coupler 313 and an output coupler 315. Each resonator section 340, 360 and 380 may comprise a pattern of signal conductive line 303. In addition, there is shown programmable impedances Z₁₂, Z₂₃ and Z₁₃. The pattern of signal conductive line 303 is an exemplary embodiment. The invention is not limited to this type of structure, as any number of patterns may be utilized to create a bandpass filter. Changing the shape may change the frequency response of the MS-BPF 350. In this manner, the frequency response may be tuned to a particular range with the design of the signal conductive line 303, and fine tuning may be accomplished by adjusting the programmable impedances Z₁₂, Z₂₃ and Z₁₃.

The signal conductive line 303 may be as described with respect to FIG. 3A. The programmable impedances may comprise inductors and/or capacitors that may be programmably adjusted to modify the center frequency and bandwidth of the MS-BPF 350. The number and location of the impedances Z₁₂, Z₂₃ and Z₁₃ is not limited to the configuration shown in FIG. 3B. Accordingly, any number of impedances may be used at multiple locations within the MS-BPF 350.

The input and output couplers 313 and 315 may comprise inductive tap couplings for communicating signals into and out of the MS-BPF 350, respectively. In another embodiment of the invention, the input and output couplers 313 and 315 may comprise series-capacitance couplers.

In operation, an input signal may be communicated to the MS-BPF 350 via the input coupler 313. The desired frequency of operation may be configured by adjusting the impedances of the programmable impedances Z₁₂, Z₂₃ and Z₁₃. The filtered output signal may be communicated from the output coupler 315. In another embodiment of the invention, tuning may be accomplished by suspending portions of the MS-BPF 350 over the substrate with an air gap. By adjusting this air gap, via piezoelectric or electrostatic means, for example, the capacitance of the structure may be altered, adjusting the bandpass filter frequency.

FIG. 3C is a block diagram illustrating a cross-sectional view of a coplanar waveguide bandpass filter, in accordance with an embodiment of the invention. Referring to FIG. 3C, there is shown a coplanar waveguide bandpass filter (CPW-BPF) 300. The CPW-BPF 300 may comprise a passivation layer 301, a signal conductive line 303A, a ground conductive line 303B, an oxide layer 307 and a substrate 309.

The passivation layer 301 may comprise an oxide, nitride or other insulating layer that may provide electrical isolation between the conductive lines 303A and 303B and other circuitry on the substrate 309. The passivation layer 301 may provide protection from environmental factors for the underlying layers of the CPW-BPF 300. In addition, the passivation layer 301 may be selected based on its dielectric constant and its effect on the electric field that may be present between conductive lines.

The signal and ground conductive lines 303A and 303B may comprise metal traces embedded in the oxide layer 307. In another embodiment of the invention, the conductive lines may comprise polysilicon or other conductive material. The separation and the voltage potential between the signal conductive line 303A and the ground conductive line 303B, as well as the dielectric constant of the oxide 307 may determine the electric field generated therein.

The oxide layer 307 may comprise SiO₂ or other oxide material that may provide a high resistance insulating layer between the signal conductive line 303A and the ground conductive line 303B. In addition, the oxide layer 307 may provide a high resistance insulating layer between the substrate 309 and the conductive lines 303A and 303B.

The substrate 309 may comprise a semiconductor or insulator material that may provide mechanical support for the CPW-BPF 300 and other devices that may be integrated. The substrate 309 may comprise Si, GaAs, sapphire, InP, GaO, ZnO, CdTe, CdZnTe and/or Al₂O₃, for example, or any other substrate material that may be suitable for integrating coplanar waveguide structures.

In operation, an AC signal may be applied across the signal conductive line 303A and the ground conductive line 303B. The spacing between the conductive lines as well as the pattern of the conductive lines may generate an inductance and a capacitance that may be utilized for filtering purposes, specifically bandpass filtering, in the present invention. In addition, programmable impedances may be coupled across coplanar waveguide devices in the CPW-BFP 300 to tune the center frequency and bandwidth, and will be described further with respect to FIG. 3D.

FIG. 3D is a block diagram of an exemplary coplanar waveguide bandpass filter, in accordance with an embodiment of the invention. Referring to FIG. 3D, there is shown a coplanar waveguide bandpass filter 325 comprising the signal conductive line 303A and the ground conductive line 303B embedded within an oxide layer and covered with a passivation layer as described with respect to FIG. 3C. The signal conductive line 303A may be as described with respect to FIG. 3C. The pattern of the signal conductive line 303A and the ground conductive line 303B is an exemplary embodiment. The invention is not limited to this type of structure, as any number of patterns may be utilized to create a bandpass filter. The CPW-BPF 325 may be designed for a particular frequency range by determining appropriate values for the dimensions d₀-d₁₁.

In operation, an input signal may be communicated to the CPW-BPF 325 at the plus and minus inputs labeled as “In” in FIG. 3D. The desired frequency of operation may be configured by the design of the conductive lines 303A and 303B. Changing the shape may change the frequency response of the CPW-BPF 325. In this manner, the frequency response may be tuned to a particular range with the design of the signal conductive line 303A and the ground conductive line 303B. Tuning may be accomplished by adjusting the dimensions of the structure, via switching sections in and out of the structure, for example. In another embodiment of the invention, tuning may be accomplished by suspending portions of the CPW-BPF 325 over the substrate with an air gap. By adjusting this air gap, via piezoelectric or electrostatic means, for example, the capacitance of the structure may be altered, adjusting the bandpass filter frequency. The filtered output signal may be communicated out of the CPW-BPF 325 at the plus and minus outputs labeled as “Out” in FIG. 3D.

FIG. 4 is a block diagram illustrating exemplary received RF, bandpass filtered, and undersampled signals, in accordance with an embodiment of the invention. Referring to FIG. 4, there is shown an incoming RF signal plot 400, a bandpass filtered RF signal plot 420 and a subsequent undersampled signal plot 440. The RF signal plot 420 shows the multiple channels of an RF signal across the frequency band, each of which may comprise a carrier signal and a baseband modulation signal. The baseband modulation signal may comprise the desired information-containing signal. If the unfiltered incoming RF signal were undersampled, there may be excessive aliasing of the multiple channel frequencies. Thus, the unwanted channels may be filtered by a bandpass filter, such as the BPF 203, described with respect to FIG. 2.

The center frequency and bandwidth of the filter may be adjustable to allow for channel selection. In addition, the bandwidth may be adjusted to match that of the desired channel. Applying the received RF signal to a bandpass filter centered at the desired channel frequency may result in the bandpass filtered RF signal plot 420, where the unwanted channels may be filtered out. The filtered signal shown in the bandpass filtered RF signal plot 420 may then be undersampled at a sampling frequency fₛ, by the S/H circuit 205, for example, to result in the undersampled signal plot 440. The sampling frequency, fₛ, may be determined from the following relationship:

fₛ=f_{c}/N

where f_{c} is the center frequency of the desired channel and N is an integer. For an accurate extraction of the desired baseband signal, the sampling frequency may be greater than twice the bandwidth of the bandpass filter. This may be easily satisfied by using a high Q bandpass filter, such as the MS-BPF 350 or the CPW-BPF 325, since the bandwidth of the bandpass filter may be significantly less than f_{c}.

The desired baseband signal may be extracted from the undersampled signal by filtering the undersampled signal with a low pass filter, such as the LPF 211, described with respect to FIG. 2. The cutoff frequency of the low pass filter may correspond with the sampling frequency of the S/H circuit 205, ½ fₛ, for example. In this manner, the desired baseband modulation signal may be extracted.

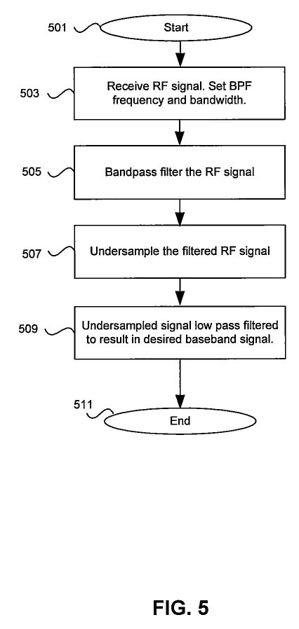

FIG. 5 is a flow diagram illustrating an exemplary programmable bandpass filter and undersampling process, in accordance with an embodiment of the invention. Referring to FIG. 5, after start step 510, in step 503, the RF signal may be received and the center frequency and bandwidth of the microstrip or coplanar waveguide bandpass filter may be set. In step 505, the signal may be filtered by the microstrip or coplanar waveguide bandpass filter, such that unwanted channels may be removed. In step 507, the filtered RF signal may be undersampled. In step 509, the baseband signal may be extracted utilizing a low pass filter, followed by end step 511.

In an embodiment of the invention, a method and system may comprise band-limiting a received wireless signal utilizing one or both of a programmable microstrip bandpass filter 350 and a coplanar waveguide bandpass filter 325 and undersampling the band-limited received wireless signal. A center frequency of the programmable microstrip bandpass filter 350 may be tuned by adjusting a capacitance Z₁₂, Z₂₃ and/or Z₁₃ or an inductance of the programmable microstrip bandpass filter 350. The bandwidth of the programmable microstrip bandpass filter 350 may be also be adjusted. A center frequency of the programmable coplanar waveguide bandpass filter 325 may be tuned by adjusting a capacitance or an inductance of the programmable coplanar waveguide bandpass filter. The bandwidth of the programmable coplanar waveguide bandpass filter 325 may also be adjusted. The band-limited, received wireless signal may be undersampled utilizing a sample and hold circuit.

Certain embodiments of the invention may comprise a machine-readable storage having stored thereon, a computer program having at least one code section for wireless communication, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for wireless communication, the method comprising:
in a wireless receiver, band-limiting a received wireless signal utilizing one or both of a programmable microstrip bandpass filter and a coplanar waveguide bandpass filter; and
undersampling said band-limited received wireless signal.

2. The method according to claim 1, comprising configuring a center frequency of said programmable microstrip bandpass filter.

3. The method according to claim 2, comprising adjusting a capacitance of said programmable microstrip bandpass filter for said configuring of said center frequency.

4. The method according to claim 2, comprising adjusting an inductance of said programmable microstrip bandpass filter for said configuring of said center frequency.

5. The method according to claim 1, comprising configuring a bandwidth of said programmable microstrip bandpass filter.

6. The method according to claim 1, comprising configuring a center frequency of said programmable coplanar waveguide bandpass filter.

7. The method according to claim 6, comprising adjusting a capacitance of said programmable coplanar waveguide bandpass filter for said configuring of said center frequency.

8. The method according to claim 6, comprising adjusting an inductance of said programmable coplanar waveguide bandpass filter for said configuring of said center frequency.

9. The method according to claim 1, comprising configuring a bandwidth of said programmable coplanar waveguide bandpass filter.

10. The method according to claim 1, comprising undersampling said band-limited, received wireless signal utilizing a sample and hold circuit.

11. A system for wireless communication, the system comprising:
one or more circuits in a wireless receiver that band-limits a received wireless signal, said one or more circuits comprising one or both of a programmable microstrip bandpass filter and a coplanar waveguide bandpass filter; and
said one or more circuits undersamples said band-limited received wireless signal.

12. The system according to claim 11, wherein said one or more circuits enable configuration of a center frequency of said programmable microstrip bandpass filter.

13. The system according to claim 12, wherein said one or more circuits enable adjustment of a capacitance of said programmable microstrip bandpass filter for said configuring of said center frequency.

14. The system according to claim 12, wherein said one or more circuits enable adjustment of an inductance of said programmable microstrip bandpass filter for said configuring of said center frequency.

15. The system according to claim 11, wherein said one or more circuits enable configuration of a bandwidth of said programmable microstrip bandpass filter.

16. The system according to claim 11, wherein said one or more circuits enable configuration of a center frequency of said programmable coplanar waveguide bandpass filter.

17. The system according to claim 16, wherein said one or more circuits enable adjustment of a capacitance of said programmable coplanar waveguide bandpass filter for said configuring of said center frequency.

18. The system according to claim 16, wherein said one or more circuits enable adjustment of an inductance of said programmable coplanar waveguide bandpass filter for said configuring of said center frequency.

19. The system according to claim 11, wherein said one or more circuits enable configuration of a bandwidth of said programmable coplanar waveguide bandpass filter.

20. The system according to claim 11, wherein said one or more circuits comprise one or more sample and hold circuits that enable undersampling of said band-limited, received wireless signal.
